(19) United States
(12) Patent Application Publication
(10) Pub. No.: US 2022/0203417 A1
(43) Pub. Date: Jun. 30, 2022

(54) CENTRIFUGALLY CAST COMPOSITE ROLL FOR ROLLING AND METHOD OF MANUFACTURING THE SAME

(71) Applicant: NIPPON STEEL ROLLS CORPORATION, Kitakyushu-city, Fukuoka (JP)

(72) Inventors: Kazunori KAMIMIYADA, Kitakyushu-city (JP); Shinya ISHIKAWA, Kitakyushu-city (JP); Ayaka YANAGITSURU, Kitakyushu-city (JP)

(73) Assignee: NIPPON STEEL ROLLS CORPORATION, Kitakyushu-city, Fukuoka (JP)

(21) Appl. No.: 17/600,644

(22) PCT Filed: Mar. 25, 2020
(86) PCT No.: PCT/JP2020/013400

§ 371 Date: Oct. 1, 2021

(30) Foreign Application Priority Data
Apr. 3, 2019 (JP) 2019-071298

(51) Int. Cl. B21B 27/02; C22C 38/54; C22C 38/52; C22C 38/50; C22C 38/48; C22C 38/46; C22C 38/44; C22C 38/04; C22C 38/02; C22C 38/00; C21D 9/38; C21D 6/00; B22D 13/02

(52) U.S. Cl. CPC B21B 27/02; B22D 13/02; C22C 38/52; C22C 38/50; C22C 38/48; C22C 38/46; C22C 38/44; C22C 38/04; C22C 38/02; C22C 38/001; C21D 9/38; C21D 6/008; C21D 6/007; C21D 6/005; C21D 6/004; C22C 38/54

(57) ABSTRACT

There is provided a centrifugally cast composite roll for rolling having excellent wear resistance and surface deterioration resistance at levels of a high-speed steel cast iron roll and having rolling incident resistance at a level of a high alloy grain cast iron roll. A centrifugally cast composite roll for rolling having an outer layer and an inner layer, the outer layer including chemical components by mass ratio:
C: 1.0 to 3.0%;
Si: 0.3 to 3.0%;
Mn: 0.1 to 3.0%;
Ni: 0.1 to 6.0%;
Cr: 0.5 to 6.0%;
Mo: 0.5 to 6.0%;
V: 3.0 to 7.0%;
Nb: 0.1 to 3.0%;
B: 0.001 to 0.1%;
N: 0.005 to 0.070%; and
the balance being Fe and inevitable impurities, wherein: the chemical composition of the outer layer satisfies following Formula (1), has a crystallization and precipitation amount of graphite suppressed to less than 0.3% by area ratio, and has 1 to 15% of MC carbide by area ratio; and the centrifugally cast composite roll for rolling does not have a cast defect having a diameter of ϕ4 mm or more at a boundary between the outer layer and the inner layer,

50×N+V<9.0 (1).

### TECHNICAL FIELD

### Cross-Reference to Related Applications

This application is based upon and claims the benefit of priority of the prior Japanese Patent Application No. 2019-071298, filed in Japan on Apr. 3, 2019, the entire contents of which are incorporated herein by reference.

The present invention relates to a centrifugally cast composite roll for rolling excellent in wear resistance, crack resistance, and surface deterioration resistance, and a method of manufacturing the same.

### BACKGROUND ART

In recent years, demands for improvement in sheet thickness accuracy and improvement in surface quality of the steel sheet increase in the field of hot-rolling steel such as shape steel, steel sheet, or steel plate. Also the roll for rolling is required to have high wear resistance, and a high-speed steel cast iron roll is increasingly applied at an earlier stand of a hot finish rolling mill for manufacturing a thin steel sheet. However, at a later stand of the hot finish rolling mill having highly probability of encountering a cobble incident, a deep crack is initiated in the roll surface at the occurrence of the cobble incident and the crack may develop during use for rolling or the like and lead to explosive spalling, and therefore a conventionally used high alloy grain cast iron roll has been mainly used.

The high alloy grain cast iron roll is composed of graphite, carbide, and a matrix structure, and has such a characteristic that there is extremely less crack initiation and development even when encountering the cobble incident, namely, excellent in rolling incident resistance. However, the high alloy grain cast iron roll is significantly inferior in wear resistance to the high-speed steel cast iron roll, and therefore a roll achieving both the rolling incident resistance and the wear resistance is expected

To respond to the demand that the roll achieving both the rolling incident resistance and the wear resistance is expected, Patent Document 1 discloses an outer layer material of a roll for hot rolling excellent in sticking resistance having a composition containing, by mass %, C: 1.8 to 3.5%, Si: 0.2 to 2%, Mn: 0.2 to 2%, Cr: 4 to 15%, Mo: 2 to 10%, and V: 3 to 10%, and further containing P: 0.1 to 0.6% and B: 0.05 to 5%, and the balance being Fe and inevitable impurities. Patent Document 1 discloses that it is preferable that the thermal treatments after casting are treatments such as a quenching treatment of quenching the roll by heating to 800° C. to 1080° C. and a tempering treatment at 300 to 600° C. once or more. However, the roll disclosed in Patent Document 1 has such a problem that since the content of P is excessive, P segregates in a grain boundary to cause embrittlement. Further, since a micro cast defect is likely to be generated at the boundary between the outer layer and the inner layer or at the boundary between the intermediate layer and the inner layer during casting, the roll has a problem of a high frequency of cracking during manufacture and a high risk that the micro cast defect remaining in the product grows and develops during use for rolling and leads to explosive spalling.

Besides, Patent Document 2 discloses a composite roll for rolling which has a structure obtained by integrally welding an outer layer and an intermediate layer which are formed of a centrifugally cast Fe-based alloy, and an inner layer formed of ductile cast iron, wherein the outer layer has a composition which contains, by mass, 1 to 3% of C, 0.3 to 3% of Si, 0.1 to 3% of Mn, 0.5 to 5% of Ni, 1 to 7% of Cr, 2.2 to 8% of Mo, 4 to 7% of V, 0.005 to 0.15% of N, and 0.05 to 0.2% of B, and the balance being Fe and inevitable impurities, the intermediate layer contains 0.025 to 0.15 mass % of B, a B content ratio in the intermediate layer is 40 to 80% of the B content of the outer layer, and the total content of carbide-forming elements in the intermediate layer is 40 to 90% of the total content of the carbide-forming elements in the outer layer. Patent Document 2 discloses that a quenching treatment is performed as needed after casting and a tempering treatment is performed once or more, and the tempering temperature is preferably 480 to 580° C. However, the roll disclosed in Patent Document 2 has such a problem that the roll has a high frequency of initiation of a crack during manufacture and a high risk of cracking because of the high B content. Further, it has turned out that the roll has a problem of surface deterioration because of a B segregation layer during use for rolling. Further, since a micro cast defect is likely to be generated at the boundary between the outer layer and the inner layer or at the boundary between the intermediate layer and the inner layer during casting, the roll has a problem of a high frequency of cracking during manufacture and a high risk that the micro defect remaining in the product grows and develops during use for rolling and leads to explosive spalling.

Further, Patent Document 3 discloses a centrifugally cast composite roll for rolling having an outer layer, the outer layer containing, by mass %, C: 2.2% to 3.01%, Si: 1.0% to 3.0%, Mn: 0.3% to 2.0%, Ni: 3.0% to 7.0%, Cr: 0.5% to 2.5%, Mo: 1.0% to 3.0%, V: 2.5% to 5.0%, Nb: more than 0 and 0.5% or less, and the balance being Fe and inevitable impurities, and satisfying a condition (a): Nb %/V %<0.1 and a condition (b): 2.1×C %+1.2×Si %−Cr %+0.5×Mo %+(V %+Nb %/2)≤13.0%. Patent Document 3 discloses that a solution heat treatment at 850° C. or higher, quenching, and tempering may be performed. However, it has turned out that the roll disclosed in Patent Document 3 has such a problem that the roll is significantly inferior in wear resistance to a high-speed steel cast iron roll and has surface deterioration because graphite excessively crystallizes. Further, since a micro cast defect is likely to occur at the boundary between the outer layer and the inner layer or at the boundary between the intermediate layer and the inner layer during casting, the roll has a problem of a high frequency of cracking during manufacture and a high risk that the micro defect remaining in the product grows and develops during use for rolling and leads to explosive spalling.

### PRIOR ART DOCUMENT

### Patent Document

Patent Document 1: Japanese Patent No. 4483585
Patent Document 2: International Publication Pamphlet No. WO 2018/147370
Patent Document 3: Japanese Patent No. 6313844

### DISCLOSURE OF THE INVENTION

### Problems to be Solved by the Invention

However, since a micro cast defect is likely to occur at the boundary between the outer layer and the inner layer or at the boundary between the intermediate layer and the inner layer during casting, the rolls disclosed in the above Patent Documents 1 to 3 each have a problem of a high frequency of cracking during manufacture and a high risk that the micro cast defect remaining in the product grows and develops during use for rolling and leads to explosive spalling.

In consideration of the above circumstances, an object of the present invention is to provide a centrifugally cast composite roll for rolling having excellent wear resistance and surface deterioration resistance at levels of a high-speed steel cast iron roll and having rolling incident resistance at a level of a high alloy grain cast iron roll, and a method of manufacturing the same.

### Means for Solving the Problems

To achieve the above object, according to the present invention, there is provided a centrifugally cast composite roll for rolling having an outer layer and an inner layer, the outer layer including chemical components by mass ratio:
C: 1.0 to 3.0%;
Si: 0.3 to 3.0%;
Mn: 0.1 to 3.0%;
Ni: 0.1 to 6.0%;
Cr: 0.5 to 6.0%;
Mo: 0.5 to 6.0%;
V: 3.0 to 7.0%;
Nb: 0.1 to 3.0%;
B: 0.001 to 0.1%;
N: 0.005 to 0.070%; and
the balance being Fe and inevitable impurities, wherein: the chemical composition of the outer layer satisfies following Formula (1), has a crystallization and precipitation amount of graphite suppressed to less than 0.3% by area ratio, and has 1 to 15% of MC carbide by area ratio; and the centrifugally cast composite roll for rolling does not have a cast defect having a diameter of ϕ4 mm or more at a boundary between the outer layer and the inner layer,

50×N+V<9.0 (1).

Further, according to the present invention, there is provided a centrifugally cast composite roll for rolling having an outer layer, an intermediate layer, and an inner layer, the outer layer including chemical components by mass ratio:
C: 1.0 to 3.0%;
Si: 0.3 to 3.0%;
Mn: 0.1 to 3.0%;
Ni: 0.1 to 6.0%;
Cr: 0.5 to 6.0%;
Mo: 0.5 to 6.0%;
V: 3.0 to 7.0%;
Nb: 0.1 to 3.0%;
B: 0.001 to 0.1%;
N: 0.005 to 0.070%; and
the balance being Fe and inevitable impurities, wherein: the chemical composition of the outer layer satisfies following Formula (1), has a crystallization and precipitation amount of graphite suppressed to less than 0.3% by area ratio, and has 1 to 15% of MC carbide by area ratio; and the centrifugally cast composite roll for rolling does not have a cast defect having a diameter of 4 mm or more at a boundary between the intermediate layer and the inner layer,

50×N+V<9.0 (1).

The outer layer may further include one or more of chemical components by mass ratio:
Ti: 0.005 to 0.3%;
W: 0.01 to 6.0%;
Co: 0.01 to 2.0%; and
S: 0.3% or less.

Further, according to the present invention from another aspect, there is provided a method of manufacturing the above centrifugally cast composite roll for rolling, wherein a relation between an outer layer casting start temperature (Ti) and an outer layer liquidus temperature (T2) in a centrifugal casting method satisfies following Formula (2),

40° C.≤T1−T2≤120° C. (2).

### Effect of the Invention

According to the present invention, it is possible to prevent the generation of a cast defect at the boundary between the outer layer and the inner layer or at the boundary between the intermediate layer and the inner layer, thus preventing a cracking trouble during manufacture and a trouble that the micro cast defect at the boundary remaining in the product grows during use for rolling and leads to explosive spalling. As a result, it is possible to manufacture a centrifugally cast composite roll for rolling having both excellent wear resistance and surface deterioration resistance at levels of the high-speed steel cast iron roll and having rolling incident resistance at a level of the high alloy grain cast iron roll. The centrifugally cast composite roll for rolling according to the present invention is suitably applied especially to a later stand of hot finish rolling required to have operational stability in a hot strip mill.

### EMBODIMENTS FOR CARRYING OUT THE INVENTION

Hereinafter, an embodiment of the present invention will be explained. Note that the expression of “%” represents “mass %” in this description.

A centrifugally cast composite roll for rolling according to the present invention has an outer layer provided for rolling. The centrifugally cast composite roll for rolling further has an intermediate layer and an inner layer inside the outer layer or an axial core material composed of an inner layer. Examples of an inner layer material constituting the inner layer include materials having toughness such as high-grade cast iron, ductile cast iron and the like, and examples of an intermediate layer material constituting the intermediate layer include an adamite material and graphitic steel.

The centrifugally cast outer layer is formed of an Fe-based alloy including by mass ratio: 1.5 to 3.0% of C; 0.3 to 3.0% of Si; 0.1 to 3.0% of Mn; 0.1 to 6.0% of Ni; 0.5 to 6.0% of Cr; 0.5 to 6.0% of Mo; 3.0 to 7.0% of V; 0.1 to 3.0% of Ni; 0.001 to 0.1% of B; 0.005 to 0.070% of N; and the balance being Fe and inevitable impurities.

Further, the structure of the outer layer is composed of (a) MC carbide, (b) eutectic carbide mainly composed of M₃C, M₂C, and M₇C₃, (c) matrix, and (d) other, in which the MC carbide is contained by 1 to 15%. Furthermore, the structure of the outer layer may contain graphite, but the presence of graphite is not essential and, for example, the crystallization and precipitation amount of graphite is suppressed to less than 0.3%.

(Reasons for Limiting Components)

Hereinafter, reasons for limiting chemical components of the outer layer according to the present invention will be explained first. Note that the expression of “%” represents “mass %” hereinafter unless otherwise described.
C: 1.0 to 3.0%

C mainly combines with Fe, Cr, Mo, Nb, V, W and the like to form various hard carbides. Besides, C may form graphite in some cases. Further, C forms a solid solution with a matrix to produce pearlite, bainite, and martensite phases and the like. A larger amount of C contained is more effective in improvement in wear resistance, but when C exceeds 3.0%, coarse carbide or graphite is formed, causing a decrease in toughness and causing surface deterioration. Besides, when C is less than 1.0%, the amount of carbide is little and the securement of hardness is difficult, causing deterioration in wear resistance. Accordingly, the range of C is set to 1.0 to 3.0%. A more preferable range is 1.5 to 2.5%.
Si: 0.3 to 3.0%

Si is necessary for suppressing the generation of a defect of an oxide owing to deoxidation of a molten metal. Further, Si has an action of improving the fluidity of the molten metal to prevent a cast defect. When Si is less than 0.3%, this effect becomes insufficient to increase the risk that the cast defect remains in a layer used for rolling of the outer layer. Accordingly, 0.3% or more of Si is contained. However, when exceeding 3.0%, Si decreases the toughness, causing a decrease in crack resistance. Accordingly, the range of Si is set to 0.3 to 3.0%. A more preferable range is 0.5 to 2.0%.
Mn: 0.1 to 3.0%

Mn is added for a purpose of deoxidizing and desulfurizing actions. Further, Mn combines with S to form MnS. MnS has a lubrication action and thus has an effect in preventing sticking of a material to be rolled. Therefore, it is preferable that MnS is contained in a range of causing no side effect. When Mn is less than 0.1%, these effects are insufficient, whereas when Mn exceeds 3.0%, the toughness decreases. Accordingly, the range of Mn is set to 0.1 to 3.0%. A more preferable range is 0.3 to 1.2%.
Ni: 0.1 to 6.0%

Ni has an action of improving the hardenability of the matrix and is an element which prevents the formation of pearlite during cooling and accelerates bainitization and is thereby effective in strengthening the matrix, and therefore 0.1% or more of Ni needs to be contained. However, when more than 6.0% of Ni is contained, the amount of retained austenite is excessive to make it difficult to secure the hardness and may cause deformation, surface deterioration or the like during use for hot rolling in some cases. Accordingly, the range of Ni is set to 0.1 to 6.0%. A more preferable range is 0.3 to 5.5%.
Cr: 0.5 to 6.0%

Cr is added for increasing the hardenability, increasing the hardness, increasing the resistance to temper softening, stabilizing the carbide hardness, and so on. However, when Cr exceeds 6.0%, the amount of eutectic carbide becomes excessive to decrease the surface deterioration resistance and the toughness, and therefore the upper limit is set to 6.0%. On the other hand, when Cr is less than 0.5%, the above effects cannot be obtained any longer. Accordingly, the range of Cr is set to 0.5 to 6.0%. A more preferable range is 1.0 to 5.5%.
Mo: 0.5 to 6.0%

Mo combines mainly with C to form hard carbide to contribute to the improvement in wear resistance and to improve the hardenability of the matrix, and therefore at least 0.5% or more of Mo needs to be contained. On the other hand, when Mo exceeds 6.0%, coarse carbide or graphite is formed to decrease the surface deterioration resistance and the toughness. Accordingly, the range of Mo is set to 0.5 to 6.0%. A more preferable range is 0.7 to 5.5%.
V: 3.0 to 7.0%

V is an element important especially for improving the wear resistance. More specifically, V is an important element which combines with C to form high-hardness MC carbide greatly contributing to the wear resistance. When to V is less than 3.0%, the amount of MC carbide is insufficient and the improvement in wear resistance is insufficient, whereas when V exceeds 7.0%, it becomes a region where low-density MC carbide independently crystallizes as a primary crystal. In the case of manufacture by the centrifugal casting method, the density of the MC carbide is smaller than the density of the molten metal, and therefore the MC carbide gravity-segregates at the boundary portion between the outer layer and the inner layer or at the boundary portion between the intermediate layer and the inner layer to form an aggregated portion of the MC carbide. The aggregated portion of the MC carbide causes the occurrence of a cast defect at the boundary portion between the outer layer and the inner layer or at the boundary portion between the intermediate layer and the inner layer. Accordingly, the range of V is set to 3.0 to 7.0%. A more preferable range is 3.5 to 6.5%.
Nb: 0.1 to 3.0%

Most of Nb does not form a solid solution with the matrix, and most of Nb forms high-hardness MC carbide to improve the wear resistance. In particular, the MC carbide produced by the addition of Nb is smaller in difference from the molten metal density than is the MC carbide produced by the addition of V, and therefore has an effect of reducing the gravity segregation owing to the centrifugal casting. When the content of Nb is less than 0.1%, the effect is insufficient, whereas when the content exceeds 3.0%, the MC carbide becomes coarse, leading to the occurrence of surface deterioration and a decrease in toughness. Accordingly, the range of Nb is set to 0.1 to 3.0%.
B: 0.001 to 0.1%

B forms a solid solution with carbide and forms a borocarbide. The borocarbide has a lubrication action and has an effect in preventing sticking of a material to be rolled. When the content of B is less than 0.001%, the effect is insufficient, whereas when the content exceeds 0.1%, B segregates in a grain boundary, leading to the occurrence of surface deterioration and a decrease in toughness. Accordingly, the range of B is set to 0.001 to 0.1%.
N: 0.005 to 0.070%

N has an effect of fining the carbide, and combines with V to form a nitride (VN) or a carbonitride (VCN). When N is less than 0.005%, the effect of fining the carbide is insufficient, whereas when the content of N exceeds 0.070%, excessive nitride (VN) or carbonitride (VCN) is formed. These gravity-segregate at the boundary portion between the outer layer and the inner layer or at the boundary portion between the intermediate layer and the inner layer to form an aggregated portion of the nitride (VN) or the carbonitride (VCN). These cause a cast defect occurring at the boundary portion between the outer layer and the inner layer or at the boundary portion between the intermediate layer and the inner layer, and therefore N needs to be suppressed to 0.070% or less. Accordingly, the range of N is set to 0.005 to 0.070%.

The basic components of the outer layer according to the present invention are as above, and the following chemical components may be appropriately selected and contained as other chemical components, in addition to the above basic components, depending on the size of the roll to be applied, the required usage characteristics of the roll and so on.
Ti: 0.005 to 0.3%

The centrifugally cast composite roll for rolling according to the present invention can contain Ti in addition to the above essential elements. Ti can be expected to have a degassing action with N and O, and can form TiCN or TiC to become a crystallization nucleus of the MC carbide. When the content of Ti is less than 0.005%, the effect cannot be expected, whereas when the content exceeds 0.3%, the viscosity of the molten metal becomes high to increase the risk of inducing a cast defect at the boundary portion between the outer layer and the inner layer or at the boundary portion between the intermediate layer and the inner layer. Accordingly, in the case of adding Ti, its range is set to 0.005 to 0.3%. A more preferable range is 0.01 to 0.2%.
W: 0.01 to 6.0%

The centrifugally cast composite roll for rolling according to the present invention can contain W in addition to the above essential elements. W forms a solid solution with the matrix similarly to Mo to strengthen the matrix, and combines with C to form hard eutectic carbide such as M₂C or M₆C to contribute to the improvement in wear resistance. To strengthen the matrix, the content of at least 0.01% or more is necessary, but when the content exceeds 6.0%, coarse eutectic carbide is formed to decrease the surface deterioration resistance and the toughness. Accordingly, in the case of adding W, its range is set to 0.01 to 6.0% Note that about the selection whether to add W or not, for example, when W is added in the case of achieving the improvement in wear resistance by increasing the amount of eutectic carbide, the effect is higher.
Co: 0.01 to 2.0%

The centrifugally cast composite roll for rolling according to the present invention can contain Co in addition to the above essential elements. Most of Co forms a solid solution with the matrix to strengthen the matrix. Therefore, Co has an action of improving the hardness and strength at high temperature. When Co is less than 0.01%, the effect is insufficient, whereas when Co exceeds 2.0%, the effect is saturated, and therefore Co is set to 2.0% or less also from a viewpoint of economical efficiency. Accordingly, in the case of adding Co, its range is set to 0.01 to 2.0%. Note that about the selection whether to add Co or not, for example, when Co is added in the case where the improvement in wear resistance is required and the increase in amount of the eutectic carbide is difficult, the effect is higher.
S: 0.3% or less

Generally, S is inevitably mixed to a certain degree from a raw material, and S forms MnS and has a lubrication action as explained above and thus has an effect of preventing the sticking of a rolled steel material. On the other hand, when S is excessively contained, the material becomes brittle, and therefore it is preferable to limit S to 0.3% or less.

Inevitable Impurities

The composition of the outer layer of the centrifugally cast composite roll for rolling according to the present invention is composed of the above elements and the balance being substantially Fe and inevitable impurities. In the inevitable impurities, P deteriorates the toughness and therefore it is preferable to limit P to 0.1% or less. Further, as the other inevitable impurities, elements such as Cu, Sb, Sn, Zr, Al, Te, Ce and the like may be contained in a range not impairing the characteristics of the outer layer. In order not to impair the characteristics of the outer layer, the total amount of the inevitable impurities is preferably 0.6% or less.

(Relational Expression Relating to the Chemical Composition)

Further, regarding the chemical components (chemical composition) of the outer layer of the centrifugally cast composite roll for rolling according to the present invention, the present invention needs to satisfy following Formula (1) regarding the contents (%) of N and V when adding V, Nb, Mo, Cr which are especially hard carbide-forming elements.

50×N+V<9.0 (1)

N has an effect of fining the carbide, and combines with V, Nb, Mo, Cr which are hard carbide-forming elements to form a nitride or a carbonitride. Since V is an element lower in density than the molten metal, so that if excessive nitride (VN) or carbonitride (VCN) is formed, the nitride (VN) or carbonitride (VCN) moves to an outer layer molten metal inner surface side by centrifugal force during centrifugally casting to form an aggregated portion of the nitride (VN) or carbonitride (VCN).

Besides, when an intermediate layer is interposed, the intermediate layer is cast after a lapse of a certain time after pouring the outer layer during the centrifugally casting and, in this event, the outer layer inner surface is melted to weld the intermediate layer and the outer layer. In this event, the outer layer inner surface part melted by the intermediate layer molten metal and the intermediate layer molten metal become a mixed molten metal and solidify to form an intermediate layer part. On the other hand, when the aggregated portion of the nitride (VN) or carbonitride (VCN) is formed at the outer layer inner surface, the melting point of the nitride (VN) or carbonitride (VCN) is high and is not melted by the intermediate layer molten metal. Therefore, the aggregated portion of the nitride (VN) or carbonitride (VCN) formed at the outer layer inner surface is lower in density than the intermediate layer molten metal, and thus moves to an intermediate layer molten metal inner surface by centrifugal force after pouring the intermediate layer molten metal to form an aggregated portion of the nitride (VN) or carbonitride (VCN) at an intermediate layer inner surface.

The pouring of the inner layer molten metal that is the next process is performed in such a manner that the outer layer or the outer layer and the intermediate layer are taken out of the centrifugal casting machine at the point in time of completion of solidification by the centrifugally casting, then upper and lower molds are assembled, and thereafter the inner layer molten metal is poured and cast by standing casting. In this event, in the case where the aggregated portion of the nitride (VN) or carbonitride (VCN) is formed at the outer layer inner surface or the intermediate layer inner surface, the aggregated portion of the nitride (VN) or carbonitride (VCN) remains at the boundary between the outer layer and the inner layer or at the boundary portion between the intermediate layer and the inner layer unless they are melted by the inner layer molten metal in pouring the inner layer.

However, since there are constraints that the melting point of the nitride (VN) or carbonitride (VCN) is much higher than the melting point of the inner layer molten metal and that the pouring temperature of the inner layer is set to melt only the inner surface portion of the outer layer or the intermediate layer by a minimum thickness (about 10 mm at maximum) necessary for welding, it is difficult to set the value of the pouring temperature of the inner layer to high temperature for melting the nitride (VN) or carbonitride (VCN).

Accordingly, when the aggregated portion of the nitride (VN) or carbonitride (VCN) is formed at the outer layer or intermediate layer inner surface during centrifugally casting, it becomes extremely difficult to avoid the aggregated portion of the nitride (VN) or carbonitride (VCN) from remaining at the boundary between the outer layer and the inner layer of the roll material or at the boundary of the intermediate layer and the inner layer. The aggregated portion of the nitride (VN) or carbonitride (VCN) causes the formation of a cast defect such as defective welding or blowhole at the boundary between the outer layer and the inner layer or at the boundary of the intermediate layer and the inner layer, resulting in that the harmful cast defect remains at the boundary between the outer layer and the intermediate layer or the inner layer.

Hence, the present invention satisfies Formula (1) in the outer layer of the centrifugally cast composite roll for rolling to thereby prevent the formation of the aggregated portion of the nitride (VN) or carbonitride (VCN) on the outer layer inner surface side during centrifugally casting. This makes it possible to stably supply a sound roll without forming the harmful cast defect at the boundary between the outer layer and the inner layer or at the boundary between the intermediate layer and the inner layer.

(Casting Condition in the Centrifugally Casting Method)

The centrifugally cast composite roll for rolling according to the present invention is manufactured by a general centrifugal casting method, in which a relation between an outer layer casting start temperature (Ti) and an outer layer liquidus temperature (T2) in the centrifugal casting method needs to satisfy following Formula (2).

40° C.≤T1−T2≤120° C. (2)

In the outer layer of the centrifugally cast composite roll for rolling according to the present invention, a large amount of alloy elements such as V, Nb, Mo, Cr which are hard carbide-forming elements is added, so that when T1-T2 is less than 40° C., the fluidity during centrifugally casting to cannot be sufficiently secured and the soundness of the outer layer cannot be sufficiently secured. Besides, when T1-T2 is 120° C. or more, the solidified structure becomes coarse, causing such a problem that the surface deterioration occurs during use for rolling, and therefore it is necessary to satisfy the above Formula (2).

(Crystallization and Precipitation Amount of Graphite)

In the outer layer of the centrifugally cast composite roll for rolling according to the present invention, the crystallization and precipitation amount of graphite needs to be suppressed to less than 0.3%. Since graphite is an extremely soft microstructure component, so that when a large amount of graphite crystallizes and precipitates in the outer layer of the centrifugally cast composite roll for rolling according to the present invention, the graphite causes great deterioration in wear resistance. Further, the difference in wear amount between the hard carbide or the high-hardness matrix and the soft graphite causes the occurrence of surface deterioration during rolling. The limit of the crystallization and precipitation amount of graphite not causing those adverse effects is 0.3% by area ratio. Accordingly, the crystallization and precipitation amount of graphite needs to be suppressed to less than 0.3% by area ratio.

Note that the crystallization and precipitation amount of graphite is excessive, it is possible to suppress the crystallization and precipitation amount of graphite by decreasing the additive amount of Si which is a graphitization accelerating element or by increasing the additive amount of Cr, V and so on which are graphitization inhibiting elements within the scope of the present invention.

(Content of the MC Carbide)

Further, the outer layer of the centrifugally cast composite roll for rolling according to the present invention needs to contain 1 to 15% of the MC carbide by area ratio. The centrifugally cast composite roll for rolling according to the present invention is characterized by having high wear resistance at a level of the high-speed steel cast iron roll, and the high wear resistance is satisfied by crystallizing an appropriate amount of the MC carbide with the highest hardness in the microstructure component of the roll. Accordingly, when the amount of the MC carbide is less than 1%, the wear resistance cannot be maintained. On the other hand, when the amount of the MC carbide exceeds 15%, the MC carbide crystallizing at high temperature during centrifugal casting greatly segregates in the outer layer, so that when segregating on the inner surface side, the MC carbide causes the occurrence of the cast defect at the boundary portion and causes the occurrence of surface deterioration during use for rolling. Accordingly, the amount of the MC carbide is defined to 1 to 15% by area ratio.

Note that the defined amount of the MC carbide can be satisfied by adjusting the additive amount of the elements (V, Nb, Ti) forming the MC carbide within the scope of the present invention. When the amount of the MC carbide exceeds 15% as the upper limit, the additive amount of the elements (V, Nb, Ti) forming the MC carbide only needs to be decreased within the scope of the present invention. Besides, when the amount of the MC carbide is less than 1% as the lower limit, the additive amount of the elements (V, Nb, Ti) forming the MC carbide only needs to be increased within the scope of the present invention.

(Defect at the Boundary Between the Outer Layer and the Inner Layer or at the Boundary Between the Intermediate Layer and the Inner Layer)

Generally, to improve the wear resistance of the roll, an increase in the content of V, Nb, Mo, Cr and so on which are hard carbide-forming elements is considered to be effective. However, the prior art has such a problem that a nitride (mainly VN) formed during centrifugal casting accumulates at the boundary between the outer layer and the inner layer or at the boundary between the intermediate layer and the inner layer to cause the cast defect at the boundary. Another problem is that when the micro cast defect remains in the product, the defect grows and develops during use for rolling to increase the risk of causing a cracking trouble such as spalling. In consideration of the above problems, the present inventors have found that the cast defect generated at the boundary between the outer layer and the inner layer or at the boundary between the intermediate layer and the inner layer can be suppressed by making the amounts of V and N contained in the outer layer satisfy the above Formula (1), making the relation between the outer layer casting start temperature (T1) and the outer layer liquidus temperature (T2) during centrifugal casting satisfy the above Formula (2), setting the crystallization and precipitation amount of graphite to less than 0.3% by area ratio, and containing 1 to 15% of the MC carbide by area ratio.

Specifically, the centrifugally cast composite roll for rolling according to the present invention is configured not to have a cast defect having a diameter of ϕ4 mm or more at the boundary between the outer layer and the inner layer or at the boundary between the intermediate layer and the inner layer. This structure can prevent the cast defect from growing and developing during use for rolling of the roll to cause the cracking trouble. When the size of the defect at the boundary between the outer layer and the inner layer or at the boundary between the intermediate layer and the inner layer is less than ϕ4 mm, the trouble that the cast defect grows during use for rolling and leads to explosive spalling has not occurred in the past usage record, so that the centrifugally cast composite roll for rolling according to the present invention is finally specified not to have a defect having a diameter of ϕ4 mm or more.

(Action and Effect)

As explained above, the centrifugally cast composite roll for rolling according to the present invention is configured to have the above predetermined components as the chemical composition of the outer layer, satisfy the above Formulas (1), (2), have a crystallization and precipitation amount of graphite of less than 0.3% by area ratio, and contain 1 to 15% of the MC carbide by area ratio, thereby realizing the configuration not having a cast defect having a diameter of ϕ4 mm or more at the boundary between the outer layer and the inner layer or at the boundary between the intermediate layer and the inner layer. This can prevent the cracking trouble during manufacture and the trouble that the micro cast defect at the boundary remaining in the product grows during use for rolling and leads to explosive spalling, thereby improving the rolling incident resistance. In other words, the centrifugally cast composite roll for rolling having excellent wear resistance and surface deterioration resistance at levels of the high-speed steel cast iron roll and having the rolling incident resistance at a level of the high alloy grain cast iron roll is realized.

An embodiment of the present invention has been explained, but the present invention is not limited to the embodiment. It should be understood that various changes and modifications are readily apparent to those skilled in the art within the scope of the spirit as set forth in claims, and those should also be covered by the technical scope of the present invention.

### EXAMPLES

Composite rolls composed of chemical components listed in the following Table 1, namely, Nos. 1 to 16 (present invention examples) and 17 to 28 (comparative examples) were produced as composite rolls for hot finish stand rolling having an inner layer diameter of 600 mm, a roll outer diameter of 800 mm, an outer layer thickness of 100 mm, and a body length of 2400 mm by the centrifugal casting method. The melting temperature was set to 1550° C., and T1−T2 being the difference between the outer layer casting start temperature (T1) and the outer layer liquidus temperature (T2) was set to the values listed in the following Table 1. Further, a tempering heat treatment at 400° C. to 580° C. was carried out after the casting. Note that, after the casting, the quenching and tempering treatments may be performed after heating (solution heat treatment) to a temperature at which the matrix transforms to austenite.

Here, the underlined portions in Table 1 indicate the case where the chemical components of the outer layer do not satisfy the above Formula (1), and the case where the conditions during centrifugal casting do not satisfy the above Formula (2). Further, regarding the cast defect at the boundary in Table 1, a mark “∘ absent” indicates that it is within the scope of the present invention, and a mark “x present” indicates that it is out of the scope of the present invention. Further, regarding the presence or absence of the surface deterioration during use for rolling, a sample in which the surface deterioration occurred during use for rolling is marked with a mark “x present” and a sample in which the surface deterioration did not occur during use for rolling is marked with a mark “∘ absent” in a column of the presence or absence of surface deterioration.

TABLE 1

| | OUTER LAYER COMPONENT(mass %) | | | | | | | | | | | | | | FORMULA(1) |
|---|---|---|---|---|---|---|---|---|---|---|---|---|---|---|---|
| No. | C | Si | Mn | Ni | Cr | Mo | V | Nb | B | N | Ti | W | Co | S | 50 N + V |
| 1 | 1.85 | 1.65 | 0.77 | 0.17 | 5.23 | 4.34 | 5.06 | 0.25 | 0.048 | 0.036 | — | — | — | — | 6.86 |
| 2 | 1.62 | 0.52 | 0.65 | 4.33 | 1.87 | 3.39 | 3.03 | 1.85 | 0.055 | 0.043 | — | — | — | 0.08 | 5.18 |
| 3 | 2.95 | 1.82 | 0.83 | 4.86 | 0.60 | 3.32 | 5.50 | 1.77 | 0.061 | 0.028 | — | — | — | — | 6.90 |
| 4 | 2.10 | 1.17 | 0.51 | 5.10 | 4.55 | 2.85 | 3.48 | 1.36 | 0.009 | 0.038 | — | — | — | 0.15 | 5.38 |
| 5 | 2.72 | 2.68 | 0.66 | 1.11 | 1.71 | 1.77 | 3.15 | 0.15 | 0.052 | 0.048 | — | — | — | — | 5.55 |
| 6 | 2.26 | 2.23 | 0.74 | 0.89 | 4.87 | 3.12 | 4.56 | 1.58 | 0.047 | 0.069 | — | — | — | — | 8.01 |
| 7 | 2.37 | 0.76 | 0.69 | 1.35 | 3.85 | 5.88 | 3.12 | 2.88 | 0.035 | 0.015 | — | — | — | — | 3.87 |
| 8 | 1.55 | 2.95 | 0.15 | 1.77 | 1.63 | 0.55 | 4.58 | 0.99 | 0.028 | 0.054 | 0.030 | — | — | — | 7.28 |
| 9 | 1.15 | 2.77 | 0.45 | 4.75 | 1.72 | 4.61 | 5.13 | 0.65 | 0.081 | 0.068 | 0.023 | 1.10 | — | — | 8.53 |
| 10 | 2.28 | 2.86 | 0.79 | 5.91 | 1.27 | 3.22 | 4.80 | 1.35 | 0.050 | 0.030 | 0.020 | — | — | — | 6.30 |
| 11 | 1.95 | 0.82 | 0.81 | 3.88 | 5.93 | 3.46 | 5.98 | 1.68 | 0.078 | 0.043 | 0.012 | 0.10 | — | — | 8.13 |
| 12 | 1.56 | 1.78 | 0.67 | 4.21 | 4.11 | 2.84 | 6.90 | 1.75 | 0.097 | 0.039 | 0.150 | — | — | — | 8.85 |
| 13 | 2.76 | 2.36 | 1.86 | 0.78 | 1.96 | 1.71 | 5.01 | 0.85 | 0.091 | 0.063 | 0.018 | 4.54 | — | — | 8.16 |
| 14 | 2.23 | 2.01 | 0.71 | 1.54 | 1.78 | 3.12 | 4.30 | 2.21 | 0.045 | 0.028 | 0.280 | 1.80 | — | — | 5.70 |
| 15 | 1.37 | 1.33 | 0.65 | 1.22 | 4.73 | 3.63 | 3.78 | 1.57 | 0.058 | 0.065 | — | 0.80 | 1.12 | — | 7.03 |
| 16 | 2.16 | 2.45 | 0.72 | 4.46 | 1 92 | 1.85 | 6.75 | 1.73 | 0.061 | 0.043 | — | — | — | — | 8.90 |
| 17 | 2.28 | 2.65 | 0.63 | 4.85 | 1.85 | 3.67 | 5.77 | 1.35 | 0.019 | 0.068 | — | — | — | — | 9.17 |
| 18 | 1.95 | 0.66 | 0.90 | 0.35 | 5.66 | 5.52 | 6.52 | 0.55 | 0.035 | 0.055 | 0.038 | — | — | — | 9.27 |
| 19 | 1.95 | 0.66 | 0.67 | 0.28 | 3.87 | 5.75 | 5.78 | 0.38 | 0.022 | 0.066 | 0.011 | — | — | — | 9.08 |
| 20 | 2.45 | 0.85 | 0.92 | 3.85 | 4.58 | 5.52 | 6.05 | 0.35 | 0.021 | 0.062 | — | — | — | — | 9.15 |
| 21 | 0.93 | 1.57 | 1.22 | 0.45 | 1.85 | 1.55 | 5.92 | 0.26 | 0.052 | 0.064 | — | — | — | — | 9.12 |
| 22 | 3.27 | 2.83 | 0.86 | 4.87 | 1.75 | 0.82 | 6.15 | 1.35 | 0.045 | 0.063 | — | — | — | — | 9.30 |
| 23 | 2.95 | 0.92 | 0.93 | 0.65 | 3.77 | 5.15 | 6.38 | 3.18 | 0.013 | 0.058 | 0.021 | — | — | — | 9.28 |
| 24 | 2.63 | 1.85 | 0.63 | 6.38 | 5.35 | 5.23 | 7.18 | 0.52 | 0.062 | 0.039 | — | 1.55 | 0.52 | — | 9.13 |
| 25 | 2.63 | 1.85 | 0.63 | 4.85 | 6.22 | 5.23 | 6.12 | 3.23 | 0.380 | 0.067 | — | — | — | — | 9.47 |
| 26 | 2.52 | 1.81 | 0.68 | 1.26 | 3.52 | 2.76 | 7.25 | 2.73 | 0.127 | 0.034 | — | — | — | — | 8.95 |
| 27 | 2.13 | 0.65 | 0.66 | 0.62 | 3.85 | 6.17 | 5.07 | 0.54 | 0.015 | 0.076 | — | — | — | 0.11 | 8.87 |
| 28 | 1.95 | 2.56 | 0.88 | 1.38 | 1.21 | 3.23 | 2.86 | 0.38 | 0.028 | 0.060 | 0.320 | — | — | — | 5.86 |

| | | | | CAST | | |
|---|---|---|---|---|---|---|
| | | | | DEFECT AT | | |
| | CRYSTALLIZATION | MC | FORMULA | BOUNDARY | PRESENCE | |
| | AMOUNT OF | CARBIDE | (2) | PORTION | OF ABSENCE | |
| | GRAPHITE | AMOUNT | T1 − T2 | (ϕ 4 mm | OF SKIN | |
| No. | LESS THAN 0.3% | 1 TO 15% | (° C.) | OR MORE) | ROUGHNESS | NOTE |
| 1 | 0.0% | 11.0% | 65 | ∘ABSENT | ∘ABSENT | PRESENT |
| 2 | 0.0% | 9.0% | 112 | ∘ABSENT | ∘ABSENT | INVENTION |
| 3 | 0.1% | 13.0% | 43 | ∘ABSENT | ∘ABSENT | EXAMPLE |
| 4 | 0.0% | 9.0% | 71 | ∘ABSENT | ∘ABSENT | |
| 5 | 0.2% | 3.0% | 48 | ∘ABSENT | ∘ABSENT | |
| 6 | 0.0% | 10.0% | 78 | ∘ABSENT | ∘ABSENT | |
| 7 | 0.0% | 9.0% | 55 | ∘ABSENT | ∘ABSENT | |
| 8 | 0.0% | 11.0% | 87 | ∘ABSENT | ∘ABSENT | |
| 9 | 0.0% | 12.0% | 96 | ∘ABSENT | ∘ABSENT | |
| 10 | 0.0% | 10.0% | 69 | ∘ABSENT | ∘ABSENT | |
| 11 | 0.0% | 12.0% | 75 | ∘ABSENT | ∘ABSENT | |
| 12 | 0.0% | 14.5% | 82 | ∘ABSENT | ∘ABSENT | |
| 13 | 0.0% | 8.0% | 48 | ∘ABSENT | ∘ABSENT | |
| 14 | 0.0% | 7.0% | 65 | ∘ABSENT | ∘ABSENT | |
| 15 | 0.0% | 5.0% | 83 | ∘ABSENT | ∘ABSENT | |
| 16 | 0.0% | 14.0% | 57 | ∘ABSENT | ∘ABSENT | |
| 17 | 0.1% | 13.0% | 105 | x PRESENT | ∘ABSENT | COMPARATIVE |
| 18 | 0.0% | 14.0% | 110 | x PRESENT | ∘ABSENT | EXAMPLE |
| 19 | 0.0% | 10.0% | 35 | x PRESENT | x PRESENT | |
| 20 | 0.0% | 13.0% | 128 | x PRESENT | x PRESENT | |
| 21 | 0.0% | 4.0% | 75 | x PRESENT | x PRESENT | |
| 22 | 1.5% | 5.0% | 55 | x PRESENT | x PRESENT | |
| 23 | 0.0% | 16.0% | 95 | x PRESENT | x PRESENT | |
| 24 | 0.0% | 13.0% | 98 | x PRESENT | x PRESENT | |
| 25 | 0.0% | 9.5% | 75 | x PRESENT | x PRESENT | |
| 26 | 0.0% | 18.5% | 90 | x PRESENT | x PRESENT | |
| 27 | 0.0% | 12.0% | 95 | x PRESENT | x PRESENT | |
| 28 | 0.5% | 1.8% | 83 | x PRESENT | x PRESENT | |

Thereafter, to check the presence or absence of the cast defect at the boundary between the outer layer and the inner layer or at the boundary between the intermediate layer and the inner layer in each composite roll, the presence or absence of the cast defect was investigated by ultrasonic testing inspection. Regarding the ultrasonic testing, the sensitivity was adjusted to be able to defect a defect of ϕ4 mm or more by a standard test block STB-G for ultrasonic testing (JIS Z 2345), and a flaw at the boundary between the outer layer and the inner layer or at the boundary between the inner layer and the inner layer in the composite roll was detected by the normal beam technique (use probe: 5Z20N).

Further, for the test block sampled from the outer layer part of the produced roll, the area ratios of graphite and the MC carbide in the structure were measured and it was investigated whether graphite was less than 0.3% and whether the MC carbide was in a range of 1 to 15%. The area ratio of graphite was obtained by mirror finishing each test block, taking an optical micrograph (×100) in a non-etching state, and performing measurement using image analysis software for the obtained image. Further, the area ratio of the MC carbide was obtained by taking an optical micrograph (×100) in a state of being colored with Murakami reagent, and performing measurement using image analysis software for the obtained image.

As a result, in the rolls in the present invention examples Nos. 1 to 16 in each of which the chemical components of the outer layer were within the predetermined ranges explained in the embodiment and the conditions relating to the above Formula (1) and Formula (2) were within the scope of the present invention, a harmful cast defect was not detected at the boundary between the outer layer and the inner layer or at the boundary between the intermediate layer and the inner layer.

On the other hand, in the rolls in the comparative examples Nos. 17 to 28 in each of which the conditions relating to the above Formula (1) and Formula (2) were out of the scope of the present invention, a harmful cast defect was detected at the boundary between the outer layer and the inner layer or at the boundary between the intermediate layer and the inner layer.

From the above-explained results of the examples, it is found that the centrifugally cast composite roll for rolling is configured to have chemical components of the outer layer within the predetermined ranges, have the conditions relating to the above Formula (1) and Formula (2) within the scope of the present invention, have a crystallization and precipitation amount of graphite of less than 0.3% by area ratio, and contain 1 to 15% of the MC carbide by area ratio, thereby realizing a centrifugally cast composite roll for rolling having excellent wear resistance and surface deterioration resistance at levels of the high-speed steel cast iron roll and having rolling incident resistance at a level of the high alloy grain cast iron roll.

### INDUSTRIAL APPLICABILITY

The present invention is applicable to a centrifugally cast composite roll for rolling having excellent wear resistance, crack resistance, and surface deterioration resistance, and a method of manufacturing the same.

1. A centrifugally cast composite roll for rolling having an outer layer and an inner layer,
the outer layer comprising chemical components by mass ratio:
C: 1.0 to 3.0%;
Si: 0.3 to 3.0%;
Mn: 0.1 to 3.0%;
Ni: 0.1 to 6.0%;
Cr: 0.5 to 6.0%;
Mo: 0.5 to 6.0%;
V: 3.0 to 7.0%;
Nb: 0.1 to 3.0%;
B: 0.001 to 0.1%;
N: 0.005 to 0.070%; and
the balance comprising Fe and inevitable impurities, wherein:
the chemical composition of the outer layer satisfies following Formula (1), has a crystallization and precipitation amount of graphite suppressed to less than 0.3% by area ratio, and has 1 to 15% of MC carbide by area ratio; and
the centrifugally cast composite roll for rolling does not have a cast defect having a diameter of ϕ4 mm or more at a boundary between the outer layer and the inner layer,
50×N+V<9.0 (1).

2. A centrifugally cast composite roll for rolling having an outer layer, an intermediate layer, and an inner layer,
the outer layer comprising chemical components by mass ratio:
C: 1.0 to 3.0%;
Si: 0.3 to 3.0%;
Mn: 0.1 to 3.0%;
Ni: 0.1 to 6.0%;
Cr: 0.5 to 6.0%;
Mo: 0.5 to 6.0%;
V: 3.0 to 7.0%;
Nb: 0.1 to 3.0%;
B: 0.001 to 0.1%;
N: 0.005 to 0.070%; and
the balance comprising Fe and inevitable impurities, wherein:
the chemical composition of the outer layer satisfies following Formula (1), has a crystallization and precipitation amount of graphite suppressed to less than 0.3% by area ratio, and has 1 to 15% of MC carbide by area ratio; and
the centrifugally cast composite roll for rolling does not have a cast defect having a diameter of ϕ4 mm or more at a boundary between the intermediate layer and the inner layer,
50×N+V<9.0 (1).

3. The centrifugally cast composite roll for rolling according to claim 1, wherein
the outer layer further comprises one or more of chemical components by mass ratio:
Ti: 0.005 to 0.3%;
W: 0.01 to 6.0%;
Co: 0.01 to 2.0%; and
S: 0.3% or less.

4. A method of manufacturing the centrifugally cast composite roll for rolling according to claim 1, wherein
a relation between an outer layer casting start temperature (T1) and an outer layer liquidus temperature (T2) in a centrifugal casting method satisfies following Formula (2),
40° C.≤T1−T2<120° C. (2).

5. The centrifugally cast composite roll for rolling according to claim 2, wherein the outer layer further comprises one or more of chemical components by mass ratio:
Ti: 0.005 to 0.3%;
W: 0.01 to 6.0%;
Co: 0.01 to 2.0%; and
S: 0.3% or less.

6. A method of manufacturing the centrifugally cast composite roll for rolling according to claim 2, wherein
a relation between an outer layer casting start temperature (T1) and an outer layer liquidus temperature (T2) in a centrifugal casting method satisfies following Formula (2),
40° C.≤T1−T2≤120° C. (2).

7. A method of manufacturing the centrifugally cast composite roll for rolling according to claim 3, wherein
a relation between an outer layer casting start temperature (T1) and an outer layer liquidus temperature (T2) in a centrifugal casting method satisfies following Formula (2),
40° C.≤T1−T2≤120° C. (2).

8. A method of manufacturing the centrifugally cast composite roll for rolling according to claim 5, wherein
a relation between an outer layer casting start temperature (T1) and an outer layer liquidus temperature (T2) in a centrifugal casting method satisfies following Formula (2),
40° C.≤T1−T2≤120° C. (2).
